(19) United States
(12) Patent Application Publication
(10) Pub. No.: US 2025/0033965 A1
(43) Pub. Date: Jan. 30, 2025

(54) WASTE-BASED HYPOCHLOROUS ACID PREPARATION IN A SEMICONDUCTOR FABRICATION PLANT

(71) Applicant: Taiwan Semiconductor Manufacturing Company, Ltd., Hsinchu (TW)

(72) Inventors: Chun-Ming Wang, Taichung (TW); Hsien-Li He, Hsinchu (TW); Cheng-Chieh Chen, Taoyuan (TW); Po-Hsuan Huang, Hsinchu (TW); Wan-Yu Chao, Hsinchu (TW)

(21) Appl. No.: 18/361,762

(22) Filed: Jul. 28, 2023

(51) Int. Cl. C01B 11/04

(52) U.S. Cl. CPC C01B 11/04

(57) ABSTRACT

A hypochlorous acid preparation system is provided. The hypochlorous acid preparation system includes: a hypochlorous acid preparation apparatus comprising: a first inlet, wherein sulfuric acid collected from a clean room located in a semiconductor fabrication plant enters the hypochlorous acid preparation apparatus through the first inlet; a second inlet, wherein sodium hypochlorite solution enters the hypochlorous acid preparation apparatus through the second inlet; a third inlet, wherein deionized water enters the hypochlorous acid preparation apparatus through the third inlet; and an outlet, wherein hypochlorous acid is produced in situ by mixing the sulfuric acid, the sodium hypochlorite solution, and the deionized water and exits the hypochlorous acid preparation apparatus through the outlet.

### FIELD

Embodiments of the present disclosure relate generally to the operation of a semiconductor fabrication plant (sometimes also referred to as a “fab”), and more particularly to waste-based hypochlorous acid preparation in a semiconductor fabrication plant.

### BACKGROUND

The semiconductor industry has experienced rapid growth due to ongoing improvements in the integration density of a variety of electronic components (e.g., transistors, diodes, resistors, capacitors, etc.). For the most part, improvement in integration density has resulting from iterative reduction of minimum feature size, which allows more components to be integrated into a given area.

While some integrated device manufacturers (IDMs) design and manufacture integrated circuits (IC) themselves, fabless semiconductor companies outsource semiconductor fabrication to semiconductor fabrication plants (sometimes also referred to as “fabs” or “foundries”). Semiconductor fabrication consists of a series of processes in which a device structure is manufactured by applying a series of layers onto a substrate. This involves the deposition and removal of various thin film layers. The areas of the thin film that are to be deposited or removed are controlled through photolithography. Each of the deposition and removal processes is generally followed by cleaning as well as inspection steps. Therefore, both IDMs and foundries rely on numerous semiconductor equipment and semiconductor fabrication materials, often provided by vendors. There is always a need for customizing or improving those semiconductor equipment and semiconductor fabrication materials, which results in more flexibility, reliability, and cost-effectiveness.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion.

FIG. 1 is a diagram illustrating an example operating environment of an example hypochlorous acid preparation system in accordance with some embodiments.

FIG. 2 is a diagram illustrating method for operating an example hypochlorous acid preparation system in accordance with some embodiments.

FIG. 3 is a diagram illustrating an example hypochlorous acid preparation system in accordance with some embodiments.

FIG. 4 is a diagram illustrating an example use case of an example hypochlorous acid preparation system in accordance with some embodiments.

FIG. 5 is a diagram illustrating another example use case of an example hypochlorous acid preparation system in accordance with some embodiments.

FIG. 6 is a diagram illustrating another example use case of an example hypochlorous acid preparation system in accordance with some embodiments.

### DETAILED DESCRIPTION OF THE DISCLOSURE

The following disclosure provides many different embodiments, or examples, for implementing different features of the subject matter provided. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

In addition, source/drain region(s) may refer to a source or a drain, individually or collectively dependent upon the context. For example, a device may include a first source/drain region and a second source/drain region, among other components. The first source/drain region may be a source region, whereas the second source/drain region may be a drain region, or vice versa. One of ordinary skill in the art would recognize many variations, modifications, and alternatives.

Some embodiments of the disclosure are described. Additional operations can be provided before, during, and/or after the stages described in these embodiments. Some of the stages that are described can be replaced or eliminated for different embodiments. Some of the features described below can be replaced or eliminated and additional features can be added for different embodiments. Although some embodiments are discussed with operations performed in a particular order, these operations may be performed in another logical order.

### Overview

A semiconductor fabrication plant (sometimes also referred to as a “fab”) is a factory for semiconductor device fabrication. Fabs require many pieces of expensive equipment to function. Estimates put the cost of building a new fab over one billion U.S. dollars. In some cases, the cost could be as high as tens of billion U.S. dollars.

The central part of a fab is the clean room, an area where the environment is controlled to eliminate almost all dust, since even a single speck can ruin an integrated circuit, which has nanoscale features much smaller than dust particles. The clean room must also be damped against vibration to enable nanometer-scale alignment of machines and must be kept within narrow bands of temperature and humidity. Vibration control may be achieved by using deep piles in the cleanroom's foundation that anchor the cleanroom to the bedrock, careful selection of the construction site, and/or using vibration dampers. Controlling temperature and humidity is critical for minimizing static electricity. Corona discharge sources can also be used to reduce static electricity. A fab is usually constructed in the following manner (from top to bottom): the roof, which may contain air handling equipment that draws, purifies, and cools outside air, an air plenum for distributing the air to several floor-mounted fan filter units, which are also part of the cleanroom's ceiling, the cleanroom itself, which may or may not have more than one story, a return air plenum, the clean subregion that may contain support equipment for the machines in the cleanroom such as chemical delivery, purification, recycling and destruction systems, and the ground floor, that may contain electrical equipment.

A large amount of various chemicals is consumed in the fab on a daily basis; a large amount of waste is generated in the fab every day. As the semiconductor device fabrication process gets more complex, the standards for waste liquid treatment and air pollution treatment compliance become stricter. For multinational semiconductor companies, each fab in every jurisdiction needs to follow local or state regulations as well as national regulations. The cost of waste liquid treatment and air pollution treatment compliance is not insignificant.

Among many waste chemicals, sulfuric acid (H₂SO₄) is one that has particular importance. It is a colorless, odorless, viscous liquid that is miscible with water. Sulfuric acid is a corrosive chemical and can severely burn the skin and eyes. It may cause third-degree burns and blindness on contact. Exposure to sulfuric acid mist can irritate the eyes, nose, throat, and lungs and, at higher levels, can cause a buildup of fluid in the lungs (pulmonary edema). Asthmatics are particularly sensitive to the pulmonary irritation. Repeated exposures may cause permanent damage to the lungs and teeth. The International Agency for Research on Cancer has classified “occupational exposures to strong-inorganic-acid mists containing sulfuric acid” as carcinogenic to humans. As to environmental impacts, industrial emissions of sulfuric acid can produce elevated concentrations in the atmosphere. Sulfuric acid is very corrosive and would badly burn any plants, birds, or land animals exposed to it. It has moderate chronic (long-term) toxicity to aquatic life. Chronic effects on plants, birds, or land animals have not been determined. Therefore, waste sulfuric acid has to be recycled in a fab to comply with relevant regulations.

On the other hand, hypochlorous acid (HClO) is a weak acid that forms when chlorine dissolves in water, and itself partially dissociates, forming hypochlorite (ClO⁻), an ion composed of chlorine and oxygen. Hypochlorous acid and hypochlorite are both oxidizers, and the primary disinfection agents of chlorine solutions. Hypochlorous acid cannot be isolated from these solutions due to rapid equilibration with its precursor, chlorine. Because of their strong antimicrobial properties, the related compounds sodium hypochlorite (NaClO) and calcium hypochlorite (Ca(ClO)₂) are ingredients in many commercial bleaches, deodorants, and disinfectants.

For sewage management and air pollution emission reduction in a fab, sodium hypochlorite has the risk of overdoing. On the other hand, hypochlorous acid water has the bottleneck of mass production. Electrolysis can be used to form hypochlorous acid water out of water and salt. However, mass production using electrolysis is not feasible, and the concentration of the hypochlorous acid is not high enough. Additionally, hypochlorous acid water is unstable and must be used for a short time period.

In accordance with some aspects of the disclosure, a hypochlorous acid preparation system used in a semiconductor fabrication plant is provided. The hypochlorous acid preparation system includes a hypochlorous acid preparation apparatus and a computing system. The hypochlorous acid preparation apparatus includes: a first inlet, wherein sulfuric acid collected from a clean room located in the semiconductor fabrication plant enters the hypochlorous acid preparation apparatus through the first inlet; a second inlet, wherein sodium hypochlorite solution enters the hypochlorous acid preparation apparatus through the second inlet; a third inlet, wherein deionized water enters the hypochlorous acid preparation apparatus through the third inlet; and an outlet, wherein hypochlorous acid is produced in situ by mixing the sulfuric acid, the sodium hypochlorite solution, and the deionized water and exits the hypochlorous acid preparation apparatus through the outlet. A PH meter is configured to measure a pH of the produced hypochlorous acid. One of a flow rate of the sulfuric acid and a flow rate of the sodium hypochlorite solution is adjusted, based on the pH of the produced hypochlorous acid. In some embodiments, the flow rate of the sulfuric acid is adjusted by a first control valve, and the flow rate of the sodium hypochlorite solution is adjusted by a second control valve. The computing system is configured to generate control signals to adjust the first control valve and the second control valve.

The reuse of the waste sulfuric acid can save waste sulfuric acid treatment costs (e.g., outsourcing cost or in-house treatment costs) and sulfuric acid (as a reactant) purchase fees. On the other hand, since hypochlorous acid is used by a waste liquid treatment system, the usage of sodium hypochlorite can be reduced. The concentration of free and effective residual chlorine in the liquid waste is reduced after treatment as well. In addition, the hypochlorous acid is produced in situ and used immediately, thereby avoiding the storage challenges due to the unstable nature of the hypochlorous acid. The freshness of the hypochlorous acid can be achieved.

### Example Hypochlorous Acid Preparation System and Example Method for Operating the Same

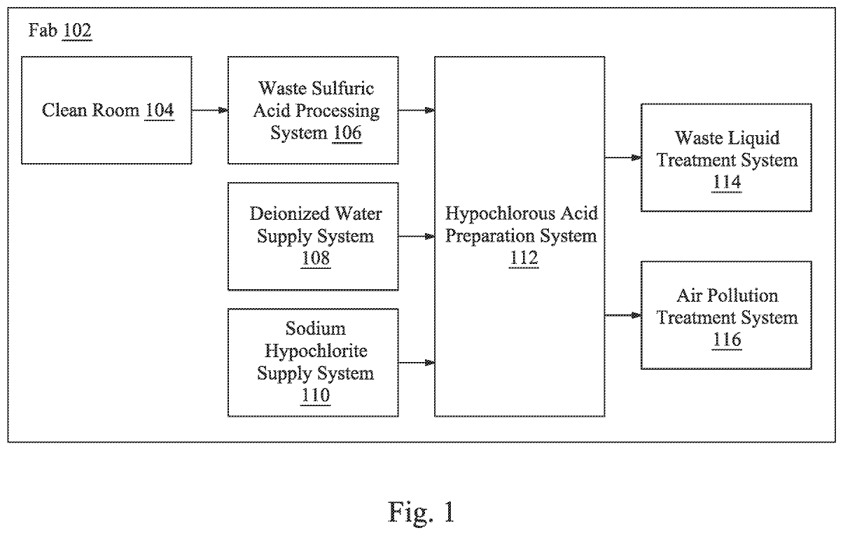

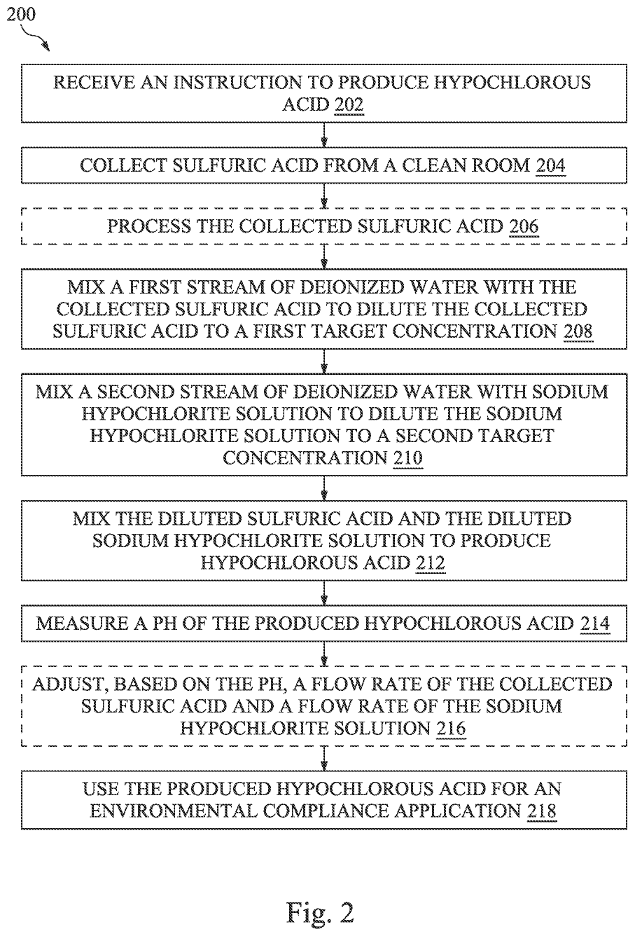

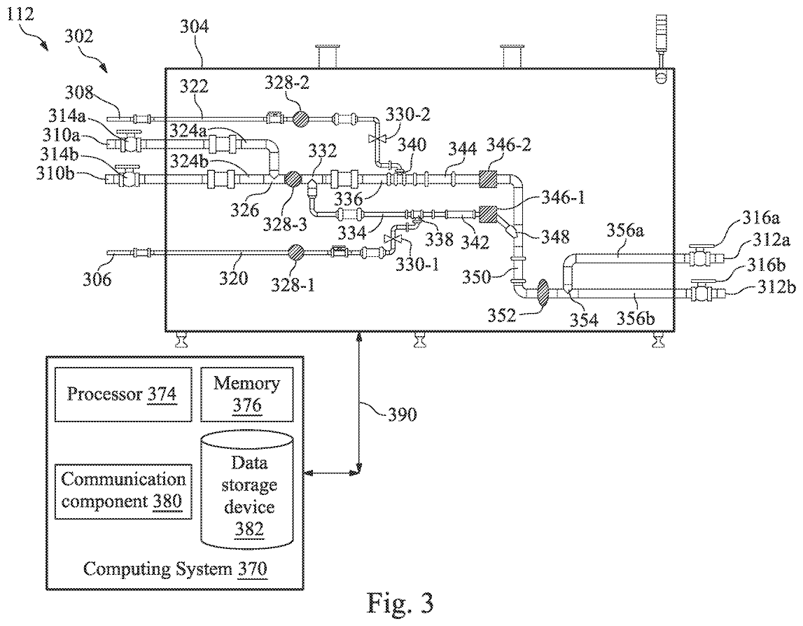

FIG. 1 is a diagram illustrating an example operating environment of an example hypochlorous acid preparation system 112 in accordance with some embodiments. In the example shown in FIG. 1, a fab 102 includes, among other components, a clean room 104, a waste sulfuric acid processing system 106, a deionized water supply system 108, a sodium hypochlorite supply system 110, a hypochlorous acid preparation system 112, a waste liquid treatment system 114, and an air pollution treatment system 116. Details of the hypochlorous acid preparation system 112 will be discussed in detail below with reference to FIG. 3. Details of the operation of the hypochlorous acid preparation system 112 will be discussed in detail below with reference to FIG. 2.

The clean room 104 is configured to perform a plurality of semiconductor fabrication processes. Semiconductor device fabrication consists of a series of processes in which a device structure is manufactured by applying a series of layers onto a substrate. This involves the deposition and removal of various thin film layers. The areas of the thin film that are to be deposited or removed are controlled through photolithography. A non-exhaustive list of processing techniques is as follows: wet cleans, surface passivation, photolithography (including photoresist coating, photoresist baking, exposure, and development), ion implantation, etching (including dry etching and wet etching), chemical vapor deposition (CVD), atomic layer deposition (ALD), physical vapor deposition (PVD), molecular beam epitaxy (MBE), plasma ashing, thermal treatments, laser lift-off, electrochemical deposition (ECD), chemical-mechanical polishing (CMP), wafer testing, through-silicon via (TSV) fabrication, wafer mounting, wafer back-grinding, wafer bonding, redistribution layer (RDL) fabrication, wafer bumping, die singulation, die attachment, die bonding, die encapsulation, IC testing, and the like.

Each of the deposition and removal processes is generally followed by cleaning as well as inspection steps. The clean room 104 is designed for one or more technology nodes, such as the 22 nm node, the 14 nm node, the 10 nm node, the 7 nm node, the 5 nm node, the 3 nm node, the 2 nm node, or even more advanced tech nodes.

As discussed above, many toxic materials are used in the fabrication processes, including (i) poisonous elemental dopants, such as arsenic, antimony, and phosphorous; (ii) poisonous compounds, such as arsine, phosphine, tungsten hexafluoride, and silane; and (iii) highly reactive liquids, such as hydrogen peroxide, fuming nitric acid, sulfuric acid, and hydrofluoric acid.

On the other hand, a large amount of waste is generated in the fab every day. The waste typically consists of heavy metals, solvents, and corrosive compounds in solid, liquid, or gas forms. Each type of waste requires unique management and disposal strategies. Typically, solid waste is processed at designated hazardous waste disposal facilities, but in some cases, the heavy metals can be recycled. Liquid waste requires purification in order to remove solids before disposal.

Liquid waste can be treated in the waste liquid treatment system 114 located in the fab 102. Although it can also be outsourced to one or more waste liquid treatment companies located outside the fab 102, treating liquid waste located in the fab 102, as shown in the example shown in FIG. 1, can provide more flexibility, cost-effectiveness, and timeliness. As discussed above, waste sulfuric acid is one type of liquid waste that is treated by the waste liquid treatment system 114 or outsourced to a waste liquid treatment company for treatment. As will be discussed below, waste sulfuric acid generated in the clean room 104, which otherwise needed treatment, can be used by the hypochlorous acid preparation system 112 as one of the reactants. In other words, waste sulfuric acid generated in the clean room 104 is reused by the hypochlorous acid preparation system 112. The reuse of the waste sulfuric acid can save waste sulfuric acid treatment costs (e.g., outsourcing costs or in-house treatment costs) and sulfuric acid (as a reactant) purchase fees. On the other hand, since hypochlorous acid is used by the waste liquid treatment system 114, the usage of sodium hypochlorite can be reduced. In one example, the consumption and purchase money of sodium hypochlorite is reduced by 20%. The concentration of free and effective residual chlorine in the liquid waste is reduced after treatment as well.

Gas waste can be treated in the air pollution treatment system 116 located in the fab 102. Although gas waste can also be outsourced to one or more waste gas treatment companies located outside the fab 102, treating gas waste located in the fab 102, as shown in the example shown in FIG. 1, can provide more flexibility, cost-effectiveness, and timeliness.

Among other pollutants, nitrogen oxides (NOx) are a family of poisonous, highly reactive gases. These gases typically form when fuel is burned at high temperatures. NOx pollution is emitted by automobiles, trucks and various non-road vehicles (e.g., construction equipment, boats, etc.) as well as industrial sources such as semiconductor device fabrication, power plants, industrial boilers, cement kilns, and turbines. NOx often appears as a brownish gas. It is a strong oxidizing agent and plays a major role in the atmospheric reactions with volatile organic compounds (VOC) that produce ozone (smog) on hot summer days.

It has been observed that spraying hypochlorous acid can remove NOx in the gas waste generated in the clean room 104 during semiconductor device fabrication. In one example, NOx is removed by about 50% by spraying hypochlorous acid. Therefore, the hypochlorous acid prepared by the hypochlorous acid preparation system 112 can be used by the air pollution treatment system 116 for NOx removal.

In the example shown in FIG. 1, waste sulfuric acid produced in the clean room 104 is delivered to the waste sulfuric acid processing system 106 for processing, including, for example, removing hydrogen peroxide. In some embodiments, the waste sulfuric acid processing system 106 can recycle the sulfuric acid collected from the clean room 104 for other purposes. In one example, the collected sulfuric acid has a concentration of about 60%. The collected sulfuric acid is then supplied to the hypochlorous acid preparation system 112 as a reactant.

The deionized water supply system 108 is configured to supply deionized water (sometimes also referred to as “DI water”) to the hypochlorous acid preparation system 112. Deionized water is water that has had almost all of its mineral ions removed, such as cations like sodium, calcium, iron, and copper, and anions such as chloride and sulfate. Deionization is a chemical process that uses specially manufactured ion-exchange resins, which exchange hydrogen and hydroxide ions for dissolved minerals, and then recombine to form water. Because most non-particulate water impurities are dissolved salts, deionization produces highly pure water that is generally similar to distilled water, with the advantage that the process is quicker and does not build up scale. Deionized water is often used as a solvent or to prepare solutions because it lacks ions that can interfere with chemical reactions. In some implementations, the deionized water supply system 108 includes a reservoir that accommodates deionized water.

The sodium hypochlorite supply system 110 is configured to supply sodium hypochlorite solution to the hypochlorous acid preparation system 112 as another reactant. In one example, the sodium hypochlorite solution has a concentration of about 12%. In some implementations, the sodium hypochlorite supply system 110 includes a reservoir that accommodates sodium hypochlorite solution. The sodium hypochlorite solution may be produced on-site or pre-produced before being transported to the location of the fab 102.

FIG. 3 is a diagram illustrating an example of the hypochlorous acid preparation system 112 in accordance with some embodiments. In the example shown in FIG. 3, the hypochlorous acid preparation system 112 includes a hypochlorous acid preparation apparatus 302 and a computing system 370. The hypochlorous acid preparation apparatus 302 and the computing system 370 communicate with each other through the communication link 390. The communication link 390 may be either wired or wireless.

The hypochlorous acid preparation apparatus 302 includes a housing 304 that accommodates other components thereof. The hypochlorous acid preparation apparatus 302 includes a first inlet 306 and a second inlet 308. Sulfuric acid that is collected by the waste sulfuric acid processing system 106 shown in FIG. 1 enters the hypochlorous acid preparation apparatus 302 through the first inlet 306 and flows in a pipeline 320. It should be understood that other types of acid chemicals (e.g., HCl) may be employed in other embodiments. Sodium hypochlorite solution provided by the sodium hypochlorite supply system 110 enters the hypochlorous acid preparation apparatus 302 through the second inlet 308 and flows in a pipeline 322. A first flowmeter 328-1 measures the flow rate of the sulfuric acid. A second flowmeter 328-2 measures the flow rate of the sodium hypochlorite solution.

The hypochlorous acid preparation system 112 further includes a third inlet 310a and a fourth inlet 310b. Deionized water provided by the deionized water supply system 108 shown in FIG. 1 enters the third inlet 310a, subject to the control of a first inlet valve 314a, and flows in a pipeline 324a. Deionized water provided by the deionized water supply system 108 shown in FIG. 1 also enters the fourth inlet 310b, subject to the control of a second inlet valve 314b, and flows in a pipeline 324b. The pipelines 324a and 324b merge at a joint 326. The coexistence of the third inlet 310a and the fourth inlet 310b provides redundancy so that deionized water is supplied even one of the pipelines 324a and 324b malfunctions. It should be understood that only one inlet and only one pipeline may be employed in other embodiments. A third flowmeter 328-3 measures the flow rate of the deionized water.

The deionized water is then split at a joint 332 and flows in both pipelines 334 and 336. The pipeline 334 and the pipeline 320 merge at a joint 338 and form a jointed pipeline 342. As a result, when a control valve 330-1, which is installed at the pipeline 320, is switched on, sulfuric acid and deionized water are mixed, and the sulfuric acid with a concentration of, for example, 60% is diluted. In one example, sulfuric acid is mixed with deionized water at a mixing ratio ranging from 1:30 to 1:60. The diluted sulfuric acid has a concentration ranging from about 1% to about 2%.

A conductivity meter 346-1 is installed at the jointed pipeline 342 and configured to measure the conductivity of the diluted sulfuric acid. By measuring the conductivity of the diluted sulfuric acid, the concentration of the diluted sulfuric acid can be determined. As will be discussed below, the determined concentration of the diluted sulfuric acid can be used to determine whether the sulfuric acid is over-diluted (i.e., the concentration is lower than a target concentration) or under-diluted (i.e., the concentration is higher than a target concentration). The flow rate of sulfuric acid can be adjusted, by the control valve 330-1, accordingly so that the concentration of the diluted sulfuric acid approaches and reaches the target concentration.

The pipeline 336 and the pipeline 322 merge at a joint 340 and form a jointed pipeline 344. As a result, when a control valve 330-2, which is installed at the pipeline 322, is switched on, sodium hypochlorite solution and deionized water are mixed, and the sodium hypochlorite solution with a concentration of, for example, 12% is diluted. In one example, sodium hypochlorite solution is mixed with deionized water at a mixing ratio of 1:10. The diluted sodium hypochlorite solution has a concentration of about 1.2%.

A conductivity meter 346-2 is installed at the jointed pipeline 344 and configured to measure the conductivity of the diluted sodium hypochlorite solution. By measuring the conductivity of the diluted sodium hypochlorite solution, the concentration of the diluted sodium hypochlorite solution can be determined. As will be discussed below, the determined concentration of the diluted sodium hypochlorite solution can be used to determine whether the sodium hypochlorite solution is over-diluted (i.e., the concentration is lower than a target concentration) or under-diluted (i.e., the concentration is higher than a target concentration). The flow rate of the sodium hypochlorite solution can be adjusted, by the control valve 330-2, accordingly so that the concentration of the diluted sodium hypochlorite solution approaches and reaches the target concentration.

The jointed pipeline 342 and the jointed pipeline 344 merge at a joint 348 and form a jointed pipeline 350. As such, the diluted sodium hypochlorite solution and the diluted sulfuric acid are mixed, and hypochlorous acid is produced according to the following chemical equation: 2NaClO+H₂SO₄→Na₂SO₄+2HClO.

The hypochlorous acid preparation system 112 further includes a pH meter 352 installed on the jointed pipeline 350. The pH meter 352 measures the pH of the produced hypochlorous acid. The pH meter 352 is a scientific instrument that measures the hydrogen-ion activity in water-based solutions, indicating its acidity or alkalinity expressed as a pH. The pH meter 352 measures the difference in electrical potential between a pH electrode and a reference electrode. In one embodiment, the pH meter 352 is an in situ pH meter (sometimes also referred to as a “pH analyzer”), which measures pH continuously during a period of time. The in situ pH meter may stand alone and be connected to the computing system 370 through a communication link 390. In other embodiments, the pH meter 352 may be a portable pH meter.

If the pH of the produced hypochlorous acid is within a predetermined range, the produced hypochlorous acid can be used for its intended purposes, such as being used by the waste liquid treatment system 114 and the air pollution treatment system 116. If the pH of the produced hypochlorous acid is not within the predetermined range, one or more parameters (e.g., the flow rate of the sulfuric acid, the flow rate of the sodium hypochlorite solution, etc.) can be adjusted so that the pH of the produced hypochlorous acid falls in the predetermined range. In one embodiment, the predetermined range of the pH of the produced hypochlorous acid is between 5.0 and 6.5.

In the example shown in FIG. 3, the produced hypochlorous acid splits at joint 354 and flows in a pipeline 356a and a pipeline 356b, respectively. The pipeline 356a is connected to a first outlet 312a, and a first outlet valve 316a is installed at the pipeline 356a. The pipeline 356b is connected to a second outlet 312b, and a second outlet valve 316b is installed at the pipeline 356b. The produced hypochlorous acid can be delivered out of the hypochlorous acid preparation apparatus 302 through one or two of the first outlet 312a and the second outlet 312b. The coexistence of the first outlet 312a and the second outlet 312b provides redundancy so that the produced hypochlorous acid is supplied even one of the pipelines 356a and 356b malfunctions. It also provides more flexibility in that the produced hypochlorous acid can be delivered to two destinations simultaneously. It should be understood that only one outlet and only one pipeline may be employed in other embodiments.

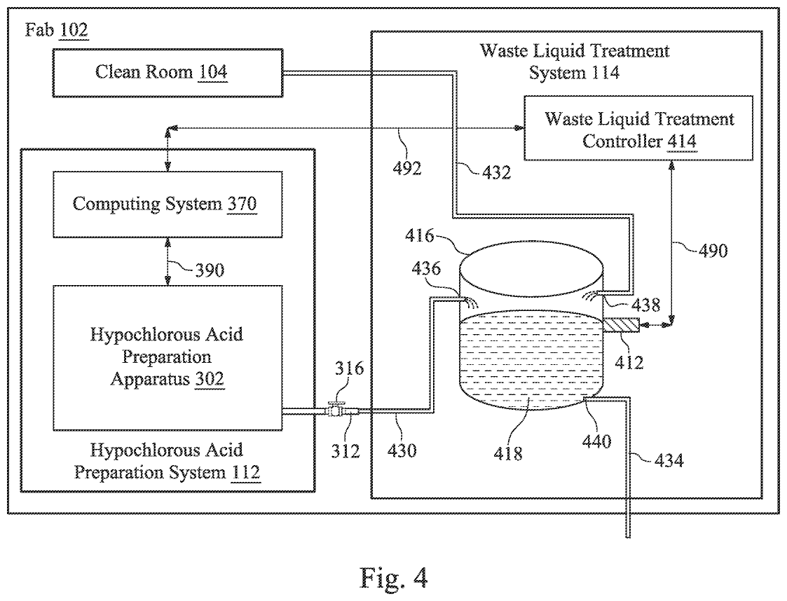

In the illustrated example of FIG. 3, the computing system 370 includes, among other components, a processor 374, a memory 376, a communication component 380, and a data storage device 382. The computing system 370 is generally configured to, among other functions, receive signals (e.g., output signals of the flowmeters 328-1, 328-2, and 328-3, the conductivity meters 346-1 and 346-2, the pH meter 352, and the like) from the hypochlorous acid preparation apparatus 302, process the signals, calculate a real-time adjustment value of an operational parameter or characteristic, transform the real-time adjustment value to an adjustment signal, and transmit the adjustment signals to the hypochlorous acid preparation apparatus 302. As will be discussed with reference to FIGS. 4-6, the computing system 370 is further configured to communicate with components outside the hypochlorous acid preparation system 112 and process signals (e.g., output signals of a level sensor 412, which will be shown in FIG. 4) received from these components.

The processor 374 is configured to process and analyze signals and execute instructions saved in the memory 376. The memory 376 is configured to store temporary variables or other intermediate information during the signal processing conducted by the processor 374.

The communication component 380 is configured to receive signals of the real-time operational parameters or characteristics in situ during operation. The communication component 380 is further configured to transmit one or more instructions from the computing system 370 to guide the operation of the hypochlorous acid preparation apparatus 302 in situ.

In some implementations, the computing system 370 is further in communication with a database through, for example, the communication component 380. The database may store any information related to the operation of the hypochlorous acid preparation system 112, such as the real-time operational parameters or the pre-established operational model.

FIG. 2 is a diagram illustrating method 200 for operating the hypochlorous acid preparation system 112 in accordance with some embodiments. In the example shown in FIG. 2, the method 200 includes operations 202, 204, 206, 208, 210, 212, 214, 216, and 218. Additional operations may be performed. Also, it should be understood that the sequence of the various operations discussed above with reference to FIG. 2 is provided for illustrative purposes, and as such, other embodiments may utilize different sequences. For instance, operation 202 can be performed after operation 210. These various sequences of operations are to be included within the scope of embodiments.

At operation 202, an instruction to produce hypochlorous acid is received by a hypochlorous acid preparation system (e.g., the hypochlorous acid preparation system 112 shown in FIG. 3). In some embodiments, the instruction is generated by a controller (e.g., a waste liquid treatment controller 414, which will be discussed below with reference to FIG. 4) outside the hypochlorous acid preparation system, and the instruction is based on some need for hypochlorous acid in the fab 102 shown in FIG. 1. The need may come from the waste liquid treatment system 114 shown in FIG. 1, the air pollution treatment system 116 shown in FIG. 1, or both.

At operation 204, sulfuric acid is collected from a clean room (e.g., the clean room 104 shown in FIG. 1). In some embodiments, the sulfuric acid is collected by a waste sulfuric acid processing system (e.g., the waste sulfuric acid processing system 106 shown in FIG. 1). The waste sulfuric would otherwise be treated or recycled if it was not used by the hypochlorous acid preparation system 112.

At operation 206, optionally, the collected sulfuric acid is processed by the waste sulfuric acid processing system 106 shown in FIG. 1. In one embodiment, hydrogen peroxide is removed from the collected sulfuric acid.

At operation 208, a first stream of deionized water (e.g., the deionized water that flows in the pipeline 334 shown in FIG. 3) is mixed with the collected sulfuric acid (e.g., the collected sulfuric acid that flows in the pipeline 320 shown in FIG. 3) to dilute the collected sulfuric acid solution to a first target concentration. In one embodiment, the mixing is performed by merging pipelines (e.g., the pipelines 334 and 320 shown in FIG. 3) and is controlled by a control valve (e.g., the control valve 330-1 shown in FIG. 3). It should be understood that other suitable mixing techniques (e.g., mixing the deionized water and the collected sulfuric acid in a container) may be employed in other embodiments.

In one example, the collected sulfuric acid has a concentration of about 60%, and the collected sulfuric acid is mixed with deionized water at a mixing ratio ranging from 1:30 to 1:60. The diluted sulfuric acid has a concentration ranging from about 1% to about 2%. As discussed above, by measuring the conductivity of the diluted sulfuric acid using a conductivity meter (e.g., the conductivity meter 346-1 shown in FIG. 3), the concentration of the diluted sulfuric acid can be determined. The determined concentration of the diluted sulfuric acid can be used to determine whether the sulfuric acid is over-diluted (i.e., the concentration is lower than the first target concentration) or under-diluted (i.e., the concentration is higher than the first target concentration). If the determined concentration of the diluted sulfuric acid deviates from the first target concentration, the flow rate of collected sulfuric acid can be adjusted, based on the deviation, accordingly so that the concentration of the diluted sulfuric acid approaches and reaches the first target concentration.

At operation 210, a second stream of deionized water (e.g., the deionized water that flows in the pipeline 336 shown in FIG. 3) is mixed with the sodium hypochlorite solution (e.g., the sodium hypochlorite solution that flows in the pipeline 322 shown in FIG. 3) to dilute the sodium hypochlorite solution to a second target concentration. In one embodiment, the mixing is performed by merging pipelines (e.g., the pipelines 336 and 322 shown in FIG. 3) and is controlled by a control valve (e.g., the control valve 330-2 shown in FIG. 3). It should be understood that other suitable mixing techniques (e.g., mixing the deionized water and the sodium hypochlorite solution in a container) may be employed in other embodiments.

In one example, the sodium hypochlorite solution has a concentration of about 12%, and the sodium hypochlorite solution is mixed with deionized water at a mixing ratio of 1:10. The diluted sodium hypochlorite solution has a concentration of about 1.2%. As discussed above, by measuring the conductivity of the diluted sodium hypochlorite solution using a conductivity meter (e.g., the conductivity meter 346-2 shown in FIG. 3), the concentration of the diluted sodium hypochlorite solution can be determined. The determined concentration of the diluted sodium hypochlorite solution can be used to determine whether the sodium hypochlorite solution is over-diluted (i.e., the concentration is lower than the second target concentration) or under-diluted (i.e., the concentration is higher than the second target concentration). If the determined concentration of the diluted sodium hypochlorite solution deviates from the second target concentration, the flow rate of the sodium hypochlorite solution can be adjusted, based on the deviation, accordingly so that the concentration of the diluted sodium hypochlorite solution approaches and reaches the second target concentration.

At operation 212, the diluted sulfuric acid and the diluted sodium hypochlorite solution are mixed to produce hypochlorous acid. In one embodiment, the mixing is performed by merging pipelines (e.g., the jointed pipelines 342 and 344 shown in FIG. 3). It should be understood that other suitable mixing techniques (e.g., mixing the diluted sulfuric acid and the diluted sodium hypochlorite solution in a container) may be employed in other embodiments.

At operation 214, a pH of the produced hypochlorous acid is measured. In one embodiment, the pH of the produced hypochlorous acid is measured using a pH meter (e.g., the pH meter 352 shown in FIG. 3). In one embodiment, the pH meter 352 is an in situ pH meter, which measures pH continuously during a period of time. If the pH of the produced hypochlorous acid is within a predetermined range (e.g., between 5.0 and 6.5), the produced hypochlorous acid can be used for its intended purposes. If the pH of the produced hypochlorous acid is not within the predetermined range, operation 216 is performed.

At operation 216, one of a flow rate of the collected sulfuric acid and a flow rate of the sodium hypochlorite solution is adjusted based on the pH of the produced hypochlorous acid. By adjusting one of the flow rate of the collected sulfuric acid and the flow rate of the sodium hypochlorite solution, the pH of the produced hypochlorous acid falls in the predetermined range, making the produced hypochlorous acid appropriate for being used by, for example, the waste liquid treatment system 114 and the air pollution treatment system 116 shown in FIG. 1.

At operation 218, the produced hypochlorous acid is used for an environmental compliance application. In one example, the environmental compliance application is a waste liquid treatment application performed by the waste liquid treatment system 114 shown in FIG. 1. In another example, the environmental compliance application is an air pollution treatment application performed by the air pollution treatment system 116 shown in FIG. 1. In yet another example, the environmental compliance application includes both a waste liquid treatment application performed by the waste liquid treatment system 114 shown in FIG. 1 and an air pollution treatment application performed by the air pollution treatment system 116 shown in FIG. 1. It should be understood that the environmental compliance application may include other types of the environmental compliance applications where the produced hypochlorous acid is suitable to be used.

FIG. 4 is a diagram illustrating an example use case of an example hypochlorous acid preparation system 112 in accordance with some embodiments. Components that are identical or similar with respect to counterpart components shown in FIG. 1 will not be repeated in detail. In the example shown in FIG. 4, the hypochlorous acid produced by the hypochlorous acid preparation system 112 is delivered to the waste liquid treatment system 114 located in the fab 102. The hypochlorous acid exits the hypochlorous acid preparation apparatus 302 through the outlet 312, subject to the control of the outlet valve 316.

The waste liquid treatment system 114 includes, among other components, a waste liquid treatment controller 414, a waste liquid tank 416, and a level sensor 412. The hypochlorous acid is delivered from the outlet 312 to a first inlet 436 of the waste liquid tank 416 through a pipeline 430. The waste liquid tank 416 accommodates liquid waste 418, which is generated in the clean room 104 and delivered from the clean room 104 to a second inlet 438 of the waste liquid tank 416 through a pipeline 432. The hypochlorous acid reacts with chemicals in the liquid waste 418. Since hypochlorous acid is an oxidizer and a disinfection agent and has strong antimicrobial properties, hypochlorous acid eliminates contaminants from the liquid waste 418 and disinfects the liquid waste 418. The treated liquid waste 418 exits the waste liquid tank 416 at an outlet 440 of the waste liquid tank 416 and is delivered to the next destination through a pipeline 434. The treated liquid waste 418 may go through additional treatment processes, including physical processes such as settling and filtration and biological processes such as slow sand filtration.

The level sensor 412 is mounted in close proximity to the waste liquid tank 416 or attached to the waste liquid tank 416. The level sensor 412 measures the level of the liquid waste 418 in the waste liquid tank 416, which becomes essentially horizontal in the waste liquid tank 416 because of gravity.

In some embodiments, the level sensor 412 is a point level sensor, which indicates whether the level of the liquid waste 418 is above or below a benchmark sensing point. When the level of the liquid waste 418 is above the benchmark sensing point, the waste liquid treatment controller 414 receives a signal transmitted by the level sensor 412 through a communication link 490. The waste liquid treatment controller 414 then transmits a control signal, based on the signal received from the level sensor 412, to the computing system 370 of the hypochlorous acid preparation system 112 through a communication link 492. The hypochlorous acid preparation system 112 then starts to prepare hypochlorous acid in response to the control signal received from the waste liquid treatment controller. The point level sensor may be one of the following types: a magnetic float level sensor, a mechanical float level sensor, a pneumatic level sensor, and a conductive level sensor.

In other embodiments, the level sensor 412 is a continuous level sensor, which measures the exact level of the liquid waste 418 within a specific range. Likewise, the waste liquid treatment controller 414 receives a signal, which contains the measured level of the liquid waste 418, transmitted by the level sensor 412 through a communication link 490. The waste liquid treatment controller 414 then transmits a control signal, based on the signal received from the level sensor 412, to the computing system 370 of the hypochlorous acid preparation system 112 through the communication link 492. The hypochlorous acid preparation system 112 then starts to prepare hypochlorous acid in response to the control signal received from the waste liquid treatment controller 414. The continuous level sensor may be one of the following types: an ultrasonic level sensor, an optical level sensor, a magnetostrictive level sensor, a resistive chain level sensor, and a hydrostatic pressure level sensor.

Since the hypochlorous acid is produced in response to the control signal, which is based on the level of the liquid waste 418, the hypochlorous acid is produced in situ and used immediately, thereby avoiding the storage challenges due to the unstable nature of the hypochlorous acid. The freshness of the hypochlorous acid can be achieved.

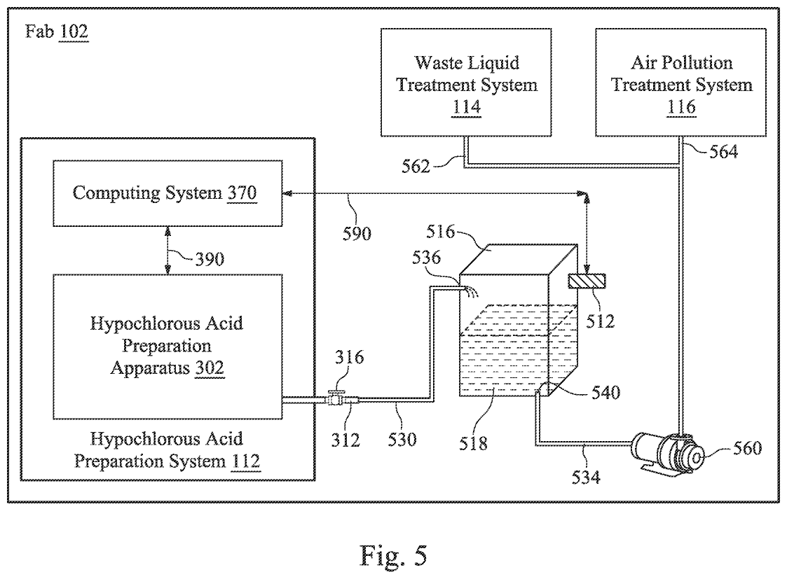

FIG. 5 is a diagram illustrating another example use case of an example hypochlorous acid preparation system 112 in accordance with some embodiments. Components that are identical or similar with respect to counterpart components shown in FIG. 1 will not be repeated in detail. In the example shown in FIG. 5, the hypochlorous acid produced by the hypochlorous acid preparation system 112 is delivered to a relay tank 516 first and to the waste liquid treatment system 114 and the air pollution treatment system 116 that are located in the fab 102 subsequently by a transfer pump 560. As such, the physical range that the hypochlorous acid prepared by the hypochlorous acid preparation system 112 is used within can be extended. In some embodiments, the physical range is extended to several hundred meters. In other embodiments, the physical range is extended to over one thousand meters. Likewise, the hypochlorous acid exits the hypochlorous acid preparation apparatus 302 through the outlet 312, subject to the control of the outlet valve 316.

The hypochlorous acid is delivered from the outlet 312 to an inlet 536 of the relay tank 516 through a pipeline 530. The relay tank 516 accommodates hypochlorous acid 518.

A level sensor 512 is mounted in close proximity to the relay tank 516 or attached to the relay tank 516. The level sensor 512 measures the level of the hypochlorous acid 518 in the relay tank 516, which becomes essentially horizontal in the relay tank 516 because of gravity. As discussed above, the level sensor 512 may be a point level sensor or a continuous level sensor. In the example shown in FIG. 5, the level sensor 512 communicates with eh computing system 370 through a communication link 590. The computing system 370 receives a signal, which contains the measured level of the hypochlorous acid 518, transmitted by the level sensor 512 through the communication link 590. The hypochlorous acid preparation system 112 then starts to prepare hypochlorous acid or stops the preparation, in response to the signal received from the waste liquid treatment controller. As such, a certain amount of the hypochlorous acid 518 is ready for use, but in the meantime, not too much hypochlorous acid 518 is prepared unnecessarily, given that hypochlorous acid 518 is unstable and must be used in a short time period. In some embodiments, the level of the hypochlorous acid 518 is maintained above a minimum level and below a maximum level. By selecting appropriate values of the minimum level and the maximum level, a fine-tuning balance between the “ready-to-go” status and the freshness can be achieved.

The hypochlorous acid 518 stored in the relay tank 516 exits the relay tank 516 and is delivered to a transfer pump 560 through a pipeline 534. The transfer pump 560 then pumps the hypochlorous acid 518, and the hypochlorous acid 518 is delivered to the waste liquid treatment system 114 and the air pollution treatment system 116 through pipelines 562 and 564, respectively. In some embodiments, the transfer pump 560 is a single-stage transfer pump. In other embodiments, the transfer pump 560 is a double-stage transfer pump, which can extend the delivery range further.

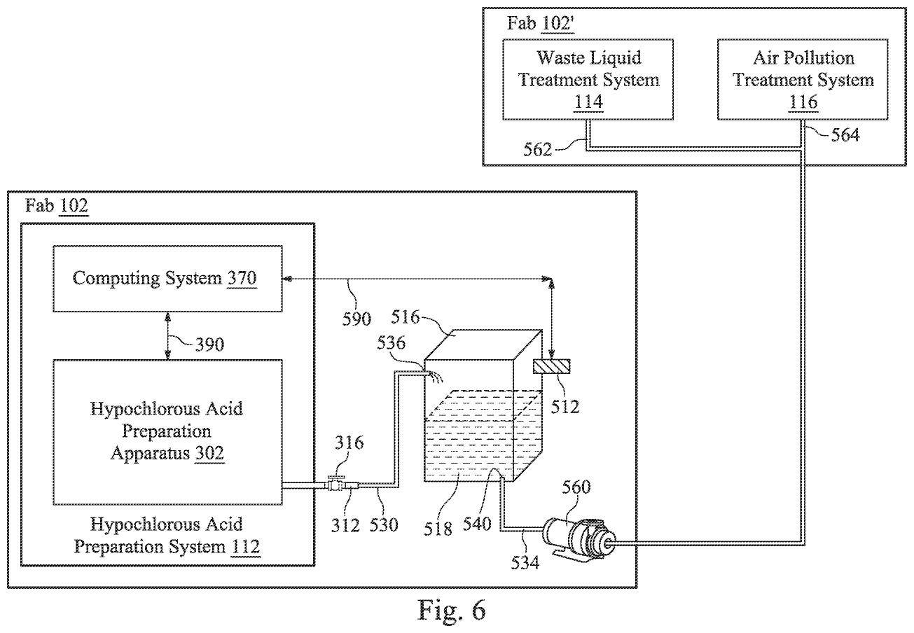

FIG. 6 is a diagram illustrating another example use case of an example hypochlorous acid preparation system 112 in accordance with some embodiments. Components that are identical or similar with respect to counterpart components shown in FIG. 1 and FIG. 5 will not be repeated in detail. In the example shown in FIG. 6, the hypochlorous acid produced by the hypochlorous acid preparation system 112 is delivered to a relay tank 516 first. However, unlike the use case shown in FIG. 5, the hypochlorous acid produced by the hypochlorous acid preparation system 112 is then delivered to the waste liquid treatment system 114 and the air pollution treatment system 116 that are located in another fab 102′ subsequently by the transfer pump 560. In some embodiments, the fab 102′ may be located in close proximity to the fab 102, for example, the same campus. In other embodiments, the fab 102′ may be located several kilometers away from the fab 102.

As such, the physical range that the hypochlorous acid prepared by the hypochlorous acid preparation system 112 is used within can be further extended. In some embodiments, the physical range is extended to several hundred meters. In other embodiments, the physical range is extended to over one kilometer. In yet other embodiments, the physical range is extended to over five kilometers. In addition, the fab 102′ and the fab 102 share the same hypochlorous acid preparation system 112 located in the fab 102, thereby enhancing cost-effectiveness because the fab 102′ does not need its own hypochlorous acid preparation system 112.

### SUMMARY

In accordance with some aspects of the disclosure, a hypochlorous acid preparation system is provided. The hypochlorous acid preparation system includes: a hypochlorous acid preparation apparatus comprising: a first inlet, wherein sulfuric acid collected from a clean room located in a semiconductor fabrication plant enters the hypochlorous acid preparation apparatus through the first inlet; a second inlet, wherein sodium hypochlorite solution enters the hypochlorous acid preparation apparatus through the second inlet; a third inlet, wherein deionized water enters the hypochlorous acid preparation apparatus through the third inlet; and an outlet, wherein hypochlorous acid is produced in situ by mixing the sulfuric acid, the sodium hypochlorite solution, and the deionized water and exits the hypochlorous acid preparation apparatus through the outlet.

In accordance with some aspects of the disclosure, a method for operating a hypochlorous acid preparation system is provided. The method includes: collecting sulfuric acid from a clean room located in a semiconductor fabrication plant; mixing a first stream of deionized water with the sulfuric acid to dilute the sulfuric acid; mixing a second stream of deionized water with sodium hypochlorite solution to dilute the sodium hypochlorite solution; and mixing the diluted sulfuric acid and the diluted sodium hypochlorite solution to produce hypochlorous acid in situ.

In accordance with some aspects of the disclosure, a semiconductor fabrication plant is provided. The semiconductor fabrication plant includes: a clean room configured to perform a plurality of semiconductor fabrication processes; and a hypochlorous acid preparation apparatus comprising: a first inlet, wherein sulfuric acid collected from the clean room enters the hypochlorous acid preparation apparatus through the first inlet; a second inlet, wherein sodium hypochlorite solution enters the hypochlorous acid preparation apparatus through the second inlet; a third inlet, wherein deionized water enters the hypochlorous acid preparation apparatus through the third inlet; and an outlet, wherein hypochlorous acid is produced in situ by mixing the sulfuric acid, the sodium hypochlorite solution, and the deionized water and exits the hypochlorous acid preparation apparatus through the outlet.

The foregoing outlines features of several embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A hypochlorous acid preparation system, comprising:
a hypochlorous acid preparation apparatus comprising:
a first inlet, wherein sulfuric acid collected from a clean room located in a semiconductor fabrication plant enters the hypochlorous acid preparation apparatus through the first inlet;
a second inlet, wherein sodium hypochlorite solution enters the hypochlorous acid preparation apparatus through the second inlet;
a third inlet, wherein deionized water enters the hypochlorous acid preparation apparatus through the third inlet; and
an outlet, wherein hypochlorous acid is produced in situ by mixing the sulfuric acid, the sodium hypochlorite solution, and the deionized water and exits the hypochlorous acid preparation apparatus through the outlet.

2. The hypochlorous acid preparation system of claim 1, wherein hydrogen peroxide is removed from the sulfuric acid collected from the clean room.

3. The hypochlorous acid preparation system of claim 1, wherein the deionized water is split into a first stream of deionized water and a second stream of deionized water.

4. The hypochlorous acid preparation system of claim 3, wherein the first stream of deionized water is mixed with the sulfuric acid to dilute the sulfuric acid.

5. The hypochlorous acid preparation system of claim 4, wherein the sulfuric acid is diluted to a first target concentration.

6. The hypochlorous acid preparation system of claim 5, wherein the hypochlorous acid preparation apparatus further comprises a first conductivity meter configured to determine the concentration of the diluted sulfuric acid.

7. The hypochlorous acid preparation system of claim 4, wherein the second stream of deionized water is mixed with the sodium hypochlorite solution to dilute the sodium hypochlorite solution.

8. The hypochlorous acid preparation system of claim 7, wherein the sodium hypochlorite solution is diluted to a second target concentration.

9. The hypochlorous acid preparation system of claim 8, wherein the hypochlorous acid preparation apparatus further comprises a second conductivity meter configured to determine the concentration of the diluted sodium hypochlorite solution.

10. The hypochlorous acid preparation system of claim 7, wherein the diluted sulfuric acid and the diluted sodium hypochlorite solution is mixed to produce hypochlorous acid.

11. The hypochlorous acid preparation system of claim 10, wherein the hypochlorous acid preparation apparatus further comprises a pH meter configured to measure a pH of the produced hypochlorous acid.

12. The hypochlorous acid preparation system of claim 11, wherein one of a flow rate of the sulfuric acid and a flow rate of the sodium hypochlorite solution is adjusted, based on the pH of the produced hypochlorous acid.

13. The hypochlorous acid preparation system of claim 12, wherein the flow rate of the sulfuric acid is adjusted by a first control valve.

14. The hypochlorous acid preparation system of claim 13, wherein the flow rate of the sodium hypochlorite solution is adjusted by a second control valve.

15. The hypochlorous acid preparation system of claim 14, further comprising:
a computing system configured to generate control signals to adjust the first control valve and the second control valve.

16. A method for operating a hypochlorous acid preparation system, the method comprising:
collecting sulfuric acid from a clean room located in a semiconductor fabrication plant;
mixing a first stream of deionized water with the sulfuric acid to dilute the sulfuric acid;
mixing a second stream of deionized water with sodium hypochlorite solution to dilute the sodium hypochlorite solution; and
mixing the diluted sulfuric acid and the diluted sodium hypochlorite solution to produce hypochlorous acid in situ.

17. The method of claim 16, further comprising:
receiving an instruction to produce the hypochlorous acid.

18. The method of claim 17, further comprising:
measuring a pH of the produced hypochlorous acid; and
adjusting one of a of a flow rate of the sulfuric acid and a flow rate of the sodium hypochlorite solution, based on the pH of the produced hypochlorous acid.

19. A semiconductor fabrication plant comprising:
a clean room configured to perform a plurality of semiconductor fabrication processes; and
a hypochlorous acid preparation apparatus comprising:
a first inlet, wherein sulfuric acid collected from the clean room enters the hypochlorous acid preparation apparatus through the first inlet;
a second inlet, wherein sodium hypochlorite solution enters the hypochlorous acid preparation apparatus through the second inlet;
a third inlet, wherein deionized water enters the hypochlorous acid preparation apparatus through the third inlet; and
an outlet, wherein hypochlorous acid is produced in situ by mixing the sulfuric acid, the sodium hypochlorite solution, and the deionized water and exits the hypochlorous acid preparation apparatus through the outlet.

20. The semiconductor fabrication plant of claim 19, further comprising:
at least one of a waste liquid treatment system or an air pollution treatment system, and wherein the produced hypochlorous acid is used by the at least one of the waste liquid treatment system or the air pollution treatment system.
